(19) United States
(12) Patent Application Publication
(10) Pub. No.: US 2025/0243384 A1
(43) Pub. Date: Jul. 31, 2025

(54) DUAL CURABLE PRESSURE SENSITIVE ADHESIVE

(71) Applicant: BASF SE, Ludwigshafen am Rhein (DE)

(72) Inventors: Singa D. TOBING, Charlotte, NC (US); Jason WOLFE, Charlotte, NC (US); Timothy KLOTS, Wyandotte, MI (US); Philip S. WILLIAMS, Charlotte, NC (US); Hiruy YIGEZU, Charlotte, NC (US); Sujith CHACKO, Charlotte, NC (US)

(21) Appl. No.: 18/853,737

(22) PCT Filed: Apr. 6, 2023
(86) PCT No.: PCT/US2023/017711

§ 371 Date: Oct. 3, 2024

Related U.S. Application Data
(60) Provisional application No. 63/328,472, filed on Apr. 7, 2022.

(51) Int. Cl. C09J 7/35; C09J 119/02; C09J 133/08

(52) U.S. Cl. CPC C09J 7/35; C09J 119/02; C09J 133/08; C09J 2301/304; C09J 2301/414; C09J 2301/416; C09J 2301/50

(57) ABSTRACT

The present disclosure provides a method of curing a hot melt adhesive composition including an acrylic copolymer and a polymeric chain extender by subjecting the composition to both UV and thermal curing.

### FIELD OF THE INVENTION

This invention pertains to a dual-curable pressure sensitive adhesive composition. More specifically, the invention pertains to a hot melt adhesive composition that may be cured by both UV and thermal cure methods.

### BACKGROUND OF THE INVENTION

While it is known to UV cure hot melt pressure sensitive adhesives, inherent limitations as to how much radiation energy maybe supplied to a given adhesive layer exists. The greater the thickness of the layer, the greater the energy need. However, it is also known that extensive radiation leads to non-uniformities in the layer. Furthermore, the addition of pigmentation to a pressure sensitive adhesive (PSA) may limit the ability of the UV radiation to penetrate the adhesive layer, thereby resulting in a poor cure.

Accordingly, there is a need for curable pressure sensitive adhesives which are not sensitive to the above identified limitations, and which may be cured without leading to non-uniformities within the adhesive layer.

### BRIEF SUMMARY OF THE INVENTION

It was an object of the invention to develop a dual-curable pressure sensitive adhesive, wherein both UV and thermal curing methods may be used. The dual-curable pressure sensitive adhesive may be applied to a substrate, such as a polymeric membrane, for example.

The following are embodiments of the invention:

A first embodiment is a method of curing a hot melt adhesive composition, the method comprising: subjecting the composition to both UV and thermal curing.

A second embodiment is the method of the first embodiment, wherein the composition comprises: an acrylic copolymer; and a polymeric chain extender.

A third embodiment is the method of either the first embodiment or the second embodiment, wherein the composition further comprises a photoinitiator.

A fourth embodiment is the method of any one of the first to third embodiments is the method of either the first embodiment or the second embodiment, wherein the composition further comprises water-borne latex adhesive.

A fifth embodiment is the method of the fourth embodiments wherein the water-borne latex adhesive comprises at least one styrene/acrylic latex, acrylic latex, styrene butadiene latex or nitrile butadiene latex derived from at least one monomer selected from the group consisting of styrene, 2-ethylhexyl acrylate, methyl acrylate, methyl methacrylate, ethyl acrylate, ethyl methacrylate, butyl acrylate, butyl methacrylate, acrylamide, acrylic acid, methacrylic acid, itaconic acid, and vinylphosphonic acid.

A sixth embodiment is the method of any one of the first through fifth embodiments, wherein the composition is applied to a substrate as a coating.

A seventh embodiment is the method of the sixth embodiment, wherein the substrate comprises one or more of a polymeric membrane, gypsum, oriented strand board (OSB), metal, plywood, plastic, paper, cardboard, glass, fiberboard, and ceramic.

An eighth embodiment is the method of the seventh embodiment, wherein the polymeric membrane is selected from the group consisting of thermoplastic membrane, ethylene-propylene-diene terpolymer rubber (EPDM), thermoplastic polyolefin (TPO), polyvinyl chloride (PVC), nonwoven polypropylene, nonwoven polyethylene, nonwoven polyethylene terephthalate, woven polypropylene, woven polyethylene, spunbond polypropylene, spunbond polyester, modified bitumen, rubber membrane, asphaltic membranes, fibrous membranes and flexible membranes selected from the group consisting of BOPP (bi-axially oriented polypropylene), polyethylene terephthalate (PET), and polyethylene furanoate (PEF), and polytrimethylene furandicarboxylate (PTF).

A ninth embodiment is the method of any one of the sixth to eighth embodiments, wherein the thickness of the coating is between 0.5 mils (12.7 μm) and 30 mils (762 μm).

A tenth embodiment is the method of the sixth to eighth embodiments, wherein the thickness of the coating is between 0.5 mil (12.7 μm) and 4 mils (101.6 μm).

An eleventh embodiment is the method of the sixth to eighth embodiments, wherein the thickness of the coating is between 5 mils (127 μm) and 20 mils (508 μm).

A twelfth embodiment is the method of the sixth to eighth embodiments, wherein the thickness of the coating is between 20 mils (508 μm) and 30 mils (762 μm).

A thirteenth embodiment is the method of any one of the first to twelfth embodiments, wherein the composition is subjected to UV curing at a wavelength of 240-280 nm.

A fourteenth embodiment is the method of any one of the first through thirteenth embodiments, wherein the composition is subjected to at least one pass of UV curing at a dose of 5-300 mJ/cm².

A fifteenth embodiment is the method of the fourteenth embodiment, wherein the composition is subjected to multiple passes of UV curing.

A sixteenth embodiment is the method of the fourteenth embodiment, wherein the composition is subjected to one pass of UV curing.

A seventeenth embodiment is the method of any one of the first to sixteenth embodiment, wherein the composition is subjected to thermal curing at a temperature of 80° C. or greater.

An eighteenth embodiment is the method of any one of the first to seventeenth embodiments, wherein the composition is subjected to thermal curing for a time period of upto about 60 minutes.

A nineteenth embodiment is the method of any one of the sixth to eighteenth embodiments, wherein the coating is applied as a single layer.

A twentieth embodiment is the method of any one of the sixth to eighteenth embodiments, wherein the coating is applied as successive layers.

A twenty-first embodiment is the method of any one of the first through twentieth embodiments, wherein the composition undergoes UV curing prior to thermal cure.

A twenty-second embodiment is the method of any one of the first through twentieth embodiments, wherein the composition undergoes thermal curing prior to UV curing.

A twenty-third embodiment is the method of any one of the first through twentieth embodiments, wherein the composition undergoes thermal and UV curing simultaneously.

A twenty-fourth embodiment is a coated article, wherein the coating comprises a hot melt adhesive, and wherein the coating undergoes both UV and thermal curing.

A twenty-fifth embodiment is the coated article of the twenty-fourth embodiment, wherein the hot melt adhesive comprises an acrylic copolymer, and a polymeric chain extender.

A twenty-sixth embodiment is the coated article of the twenty-fifth embodiment, wherein the hot melt adhesive further comprises a photoinitiator.

A twenty-seventh embodiment is the coated article of any one of the twenty-fourth to twenty-sixth embodiments, wherein the hot melt adhesive further comprises a water-borne latex adhesive.

A twenty-eighth embodiment is the coated article of the twenty-seventh embodiment, wherein the water-borne latex adhesive comprises at least one styrene/acrylic latex, acrylic latex, styrene butadiene latex or nitrile butadiene latex derived from at least one monomer selected from the group consisting of styrene, 2-ethylhexyl acrylate, methyl acrylate, methyl methacrylate, ethyl acrylate, ethyl methacrylate, butyl acrylate, butyl methacrylate, acrylamide, acrylic acid, methacrylic acid, itaconic acid, and vinylphosphonic acid.

A twenty-ninth embodiment is the coated article of any one of the twenty-fourth to twenty-eighth embodiments, wherein the coated article is suitable for use in roofing, construction, papers, tapes, and high temperature applications.

A thirtieth embodiment is the coated article of any one of the twenty-fourth to twenty-ninth embodiments, wherein the coated article is suitable for use in exterior and interior applications.

A thirty-first embodiment is a multilayer composite comprising: a hot melt adhesive comprising: an acrylic copolymer; a polymeric chain extender; a polymeric membrane; and a release liner; wherein the multilayer composite is subjected to both UV and thermal curing.

A thirty-second embodiment is the multilayer composite of the thirty-first embodiment, wherein the hot melt adhesive further comprises a photoinitiator.

A thirty-third embodiment is the multilayer composite of either the thirty-first or thirty-second embodiment, wherein the hot melt adhesive further comprises a water-borne latex adhesive.

A thirty-fourth embodiment is the multilayer composite of any one of the thirty-first to thirty-second embodiment, wherein the water-borne latex adhesive comprises at least one styrene/acrylic latex, acrylic latex, styrene butadiene latex or nitrile butadiene latex derived from at least one monomer selected from the group consisting of styrene, 2-ethylhexyl acrylate, methyl acrylate, methyl methacrylate, ethyl acrylate, ethyl methacrylate, butyl acrylate, butyl methacrylate, acrylamide, acrylic acid, methacrylic acid, itaconic acid, and vinylphosphonic acid.

A thirty-fifth embodiment is a coated article comprising: the multilayer composite of any one of the thirty-first to thirty-fourth embodiments; and a substrate.

A thirty-sixth embodiment is the coated article of the thirty-fifth embodiment, wherein the substrate comprises nonwoven polypropylene, nonwoven polyethylene, nonwoven polyethylene terephthalate, woven polypropylene, woven polyethylene, spunbond polypropylene, spunbond polyester, and combinations thereof.

The foregoing embodiments are just that and should not be read to limit or otherwise narrow the scope of any of the inventive concepts otherwise provided by the instant disclosure. While multiple embodiments are disclosed, still other embodiments will become apparent to those skilled in the art from the following detailed description, which shows and describes illustrative examples. Accordingly, the detailed description is to be regarded as illustrative in nature rather than restrictive in nature.

### DETAILED DESCRIPTION OF THE INVENTION

The following examples further illustrate the invention but, of course, should not be construed as in any way limiting its scope. Provided herein is a dual-curable hot melt adhesive, which may be applied to a substrate. The present disclosure further provides a coated article wherein the coating comprises the hot melt adhesive of the present disclosure. Coated articles may include materials suitable for roofing, construction, papers, tapes, and high temperature applications. The coated article may be suitable for use in exterior and interior applications.

UV cured acrylic pressure sensitive hot melt adhesives have found significant utility in the construction industry, for example in self-adhered roofing membrane, self-adhered air weather barrier membrane, and flooring underlayment. These applications generally require the adhesive to be coated onto an article or substrate of interest in 5-10 mils coating thickness or coat weight or more. UV-cured hot melt adhesives may be limited in their ability to undergo satisfactory curing when the adhesive coating is thicker than about 10 mils (250 μm). Likewise, the presence of pigmentation in an adhesive composition may limit the ability of UV energy to penetrate the coating, again resulting in a poor cure and a weak coating. As a further limitation, the addition of tackifiers and/or other additives to a coating composition may lower the concentration of any photoinitiators present, which again limits the efficacy of UV curing.

The present disclosure addresses these issues. The compositions of the present disclosure may be applied to a substrate prior to undergoing curing using both UV and thermal energy.

### Polymeric Membrane/Substrate

According to various embodiments described herein, the polymeric membrane may be a thermoplastic membrane, an ethylene-propylene-diene terpolymer rubber (EPDM) based membrane, a TPO based membrane, a PVC based membrane, a membrane based on other polymerics such as nonwoven polypropylene, nonwoven polyethylene, nonwoven polyethylene terephthalate, woven polypropylene, woven polyethylene, spunbond polypropylene, spunbond polyester, and combinations thereof; a rubber membrane, an asphaltic membrane, a fibrous membrane, and a flexible membrane selected from the group consisting of BOPP (bi-axially oriented polypropylene), polyethylene terephthalate (PET), and polyethylene furanoate (PEF), and polytrimethylene furandicarboxylate (PTF). These membranes may be flexible, rollable or in sheet form.

In one or more embodiments, the membrane includes EPDM membranes including those that meet the specifications of the ASTM D-4637. In other embodiments, the membrane includes thermoplastic membranes including those that meet the specifications of ASTM D-6878-03.

The polymer membrane is not particularly limited in its thickness. However, for commercial applications, and particularly for those in the roofing industry, the polymeric membrane has a thickness of from about 500 μm to about 3 mm, from about 1,000 μm to about 2.5 mm, or from about 1,500 μm to about 2 mm.

In one or more embodiments, instead of a polymeric membrane a substrate is contemplated. Generally, the substrate is more rigid compared to a polymeric membrane. For examples substrate may be gypsum, oriented strand board (OSB), metal, plywood, plastics, paper, cardboard, glass, fiberboard, and ceramics, for example. The substrate is not particularly limited in its thickness.

The dual-curable hot melt adhesive composition of the present invention may be used in various applications. For example, a pressure-sensitive adhesive layer comprising the hot melt adhesive composition of the present disclosure may be used as a pressure-sensitive adhesive sheet. Suitable applications for the use of a laminate containing the pressure-sensitive adhesive layer may include pressure-sensitive adhesives, tapes and/or films for surface protection, masking, binding, packaging, office uses, labels, decoration/display, bonding, dicing tapes, sealing, corrosion prevention waterproofing, medical/sanitary uses, prevention of glass scattering, electrical insulation, holding and fixing of electronic equipment, production of semiconductors, optical display films, pressure-sensitive adhesion-type optical films, shielding from electromagnetic waves, and sealing materials in electric and electronic parts.

When the dual-curable hot melt adhesives of the present disclosure are used in labels, suitable substrates for the labels may include plastic products, such as plastic bottles and foamed plastic cases; paper or corrugated fiberboard products, such as corrugated fiberboard boxes; glass products, such as glass bottles; metal products; and other inorganic material products, such as ceramic products.

### Dual-Curable Hot Melt Adhesive

According to various embodiments described herein, the hot-melt adhesive that may be used for forming the pressure-sensitive adhesive layer may comprise an acrylic copolymer, a polymeric chain extender, and a water-borne latex adhesive. The hot melt adhesive may further comprise at least one photoinitiator. The photoinitiator may be in the form of an additive not bonded to the poly(meth)acrylate, and/or the photoinitiator may be incorporated into the poly(meth)acrylate by polymerization.

As used herein, the term “theoretical glass transition temperature” or “theoretical Tg” refers to the estimated Tg of a polymer or copolymer calculated using the Fox equation. The Fox equation can be used to estimate the glass transition temperature of a polymer or copolymer as described, for example, in L. H. Sperling, “Introduction to Physical Polymer Science”, 2nd Edition, John Wiley & Sons, New York, p. 357 (1992) and T. G. Fox, Bull. Am. Phys. Soc, 1, 123 (1956), both of which are incorporated herein by reference. For example, the theoretical glass transition temperature of a copolymer derived from monomers a, b, . . . , and i can be calculated according to the equation below

$$1 / {T}_{g} = wa / {T}_{g a} + wb / {T}_{g b} + … + wi / {T}_{g i}$$

where wa is the weight fraction of monomer a in the copolymer, T_{ga} is the glass transition temperature of a homopolymer of monomer a, wb is the weight fraction of monomer b in the copolymer, T_{gb} is the glass transition temperature of a homopolymer of monomer b, wi is the weight fraction of monomer i in the copolymer, T_{gi} is the glass transition temperature of a homopolymer of monomer i, and T_{g} is the theoretical glass transition temperature of the copolymer derived from monomers a, b, . . . , and i.

“Copolymer” refers to polymers containing two or more monomers.

“Homopolymer” refers to a polymer formed from one species of monomer.

As used herein, the term “(meth)acrylate monomer” includes acrylate, methacrylate, diacrylate, and dimethacrylate monomers.

According to various embodiments described herein, the acrylic copolymer may be based on a polymerization of a monomer A, a monomer B, and a monomer C. The acrylic copolymer may further comprise at least one photoinitiator.

According to various embodiments described herein, monomer A may have a Tg of less than −20° C. For example, the Tg may be −30° C. or less, −40° C. or less, −45° C. or less,-50° C. or less, −55° C. or less, or −60° C. or less. The glass transition temperature can be determined by differential scanning calorimetry (DSC) by measuring the midpoint temperature using ASTM D 3418-12el.

According to various embodiments described herein, monomer B may include acrylic acid, methacrylic acid, itaconic acid, crotonic acid, fumaric acid, maleic acid, maleic anhydride, n-butylmaleic monoesters, monoethyl fumarate, monomethyl itaconate and monomethyl maleate, acrylamide and methacrylamide, N-methyl acrylamide and -methacrylamide, N-methylolacrylamide and -methacrylamide, maleic acid monoamide and diamide, itaconic acid monoamide and diamide, fumaric acid monoamide and diamide, vinylsulfonic acid or vinylphosphonic acid, and mixtures thereof.

According to various embodiments described herein, monomer C may include methyl acrylate, methyl methacrylate, ethyl methacrylate, n-butyl methacrylate, tert-butyl methacrylate, tert-butyl acrylate, isobutyl methacrylate, vinyl acetate, hydroxyethyl acrylate, hydroxyethyl methacrylate, cyclohexyl acrylate, cyclohexyl methacrylate, 2-ethoxyethyl methacrylate, 2-phenoxyethyl methacrylate, benzyl acrylate, benzyl methacrylate, hydroxypropyl methacrylate, styrene, 4-acetostyrene, acrylamide, acrylonitrile, 4-bromostyrene, n-tert-butylacrylamide, 4-tert-butylstyrene, 2,4-dimethylstyrene, 2,5-dimethylstyrene, 3,5-dimethylstyrene, isobornyl acrylate, isobornyl methacrylate, 4-methoxystyrene, methylstyrene, alpha methylstyrene, 4-methylstyrene, 3-methylstyrene, 2,4,6-trimethylstyrene, vinyl pyrrolidone, ureido methacrylate and combinations thereof.

According to some embodiments, the acrylic copolymer may contain monomer A in an amount of from 50% by weight to 99.99% by weight based on the weight of the monomers A, B and C in the copolymer.

According to some embodiments, the acrylic copolymer may contain monomer B in an amount of from 0.1% by weight to 25% by weight based on the weight of the monomers A, B and C in the copolymer.

According to some embodiments, the acrylic copolymer may contain monomer C in in an amount of from 0.1% by weight to 25% by weight based on the weight of the monomers A, B and C in the copolymer.

The acrylic copolymer may include some percentage of carboxylic acid functionality, for example acrylic acid. The acrylic acid functionality may be present in an amount of about 5 wt. % or greater, about 6 wt. % or greater, about 7 wt. % or greater, about 8 wt. % or less, about 9 wt. % or less, about 10 wt. % or less, or any value encompassed by these endpoints, based on the total weight of the polymer.

The acrylic copolymer can be prepared by known processes.

The weight average molecular weight (M_{w}) of the acrylic copolymer can be, for example, 150,000 Da or more (e.g., 160,000 Da or more, 170,000 Da or more, 180,000 Da or more, 190,000 Da or more, 200,000 Da or more, 200,000 Da or more, 210,000 Da or more, 220,000 Da or more, 230,000 Da or more, 240,000 Da or more). In some examples, the weight average molecular weight (M_{w}) of the acrylic copolymer can be 250,000 Da or less (e.g., 240,000 Da or less, 230,000 Da or less, 220,000 Da or less, 210,000 Da or less, 200,000 Da or less, 190,000 Da or less, 180,000 Da or less, 170,000 Da or less, 160,000). The weight average molecular weight (M_{w}) of the acrylic copolymer can range from any of the minimum values described above to any of the maximum values described above. For example, the weight average molecular weight (M_{w}) of the acrylic copolymer can be from 150,000 Da to 250,000 Da (e.g., from 170,000 Da to 220,000 Da, or from 190,000 Da to 200,000 Da,). The weight average molecular weight (M_{w}) of the acrylic copolymer can be determined by GPC (gel permeation chromatography).

The number average molecular weight (Mₙ) of the acrylic copolymer can be, for example, 20,000 or more (e.g., 30,000 or more, or 40,000 or more). In some examples, the number average molecular weight (Mₙ) of the acrylic copolymer can be 50,000 or less (e.g., 40,000 or less, or 30,000 or less). The number average molecular weight (Mₙ) of the acrylic copolymer can range from any of the minimum values described above to any of the maximum values described above. For example, the number average molecular weight (Mₙ) of the acrylic copolymer can be from 20,000 to 50,000 (e.g., from 30,000 to 50,000, or from 40,000 to 50,000). The number average molecular weight (Mₙ) of the acrylic copolymer can be determined by GPC (gel permeation chromatography).

The dispersity DM calculated as M_{w}/Mₙ where M_{w} is the mass-average molar mass (or molecular weight) and Mₙ is the number-average molar mass (or molecular weight) of the acrylic copolymer may be more than 5 (e.g., more than 6, or more than 7, or more than 8, or more than 9 or more than 10). The dispersity of the acrylic copolymer may be less than 11 (e.g., less than 10, less than 9, less than 8, less than 7, or less than 6). The dispersity of the acrylic copolymer can range from any of the minimum values described above to any of the maximum values described above. For example, the dispersity of the acrylic copolymer can be from 5 to 11, or from 7 to 9.

If the copolymers are to be used as contact adhesives, the acrylates and/or methacrylates used as principal monomers are preferably those whose homopolymers have glass transition temperatures below 0° C., in particular below −10° C., in particular n- and isobutyl acrylate and methacrylate, isoamyl and isooctyl acrylate and methacrylate and 2-ethylhexyl acrylate and methacrylate, as well as decyl acrylate and lauryl acrylate and methacrylate. The amount of these principal monomers is then preferably more than 60% of the total monomers.

The copolymers generally contain from, 0.01 to 10% by weight of copolymerized monomers of the general formula I, although amounts of from 0.01 to 5% by weight, based on the copolymers, are frequently sufficient. Copolymers which contain from 0.5 to 25, in particular from 5 to 15, % by weight of tetrahydrofurfur-2-yl (meth)acrylate in addition to other acrylates and monomers of the general formula I as copolymerized units often have a very low molecular weight and a low viscosity.

Polymeric chain extenders may be included in the composition. These polymeric chain extenders may comprise epoxy groups and are based on styrene, acrylate and/or methacrylate. The units bearing epoxy groups are preferably glycidyl (meth)acrylates. Copolymers that have proven advantageous have a glycidyl methacrylate content of the copolymer that is above 20% by weight, particularly preferably above 30% by weight and with particular preference above 50% by weight. The epoxy equivalent weight (EEW) in these polymers is preferably 150 to 3000 g/equivalent, and with particular preference 200 to 500 g/equivalent.

The average molecular weight (weight average) Mw of the polymeric chain extender is preferably 2000 to 25,000, in particular 3000 to 8000. The average molecular weight (number-average) Mₙ of the polymers is preferably 400 to 6000, in particular 1000 to 4000. The polydispersity (Q) is generally between 1.5 and 5.

The polymeric chain extender may have a T_{g} of about −50° C. or higher, about −45° C. or higher, about −40° C. or higher, about −35° C. or lower, about −30° C. or lower, about-25° C. or lower, or any value encompassed by these endpoints.

The polymeric chain extender may be present in the composition in an amount of about 1.0 wt. % or greater, about 1.5 wt. % or greater, about 2.0 wt. % or greater, about 2.5 wt. % or greater, about 3.0 wt. % or less, about 3.5 wt. % or less, about 4.0 wt. % or less, about 5.0 wt. % or less, or any value encompassed by these endpoints.

Polymeric chain extenders of the abovementioned type which comprise epoxy groups are marketed by way of example by BASF Resins B. V. with trademark Joncryl® ADR. Joncryl® ADR 4385, Joncryl® ADR 4368 or Joncryl ADR 4468C or Joncryl ADR 4468HP are suitable examples.

The hotmelt adhesive/poly(meth)acrylate is radiation-crosslinkable, for example by irradiation with UV light. The hotmelt adhesive then comprises at least one photoinitiator. The photoinitiator may be exclusively in the form of an additive not bonded to the poly(meth)acrylate. In another embodiment the photoinitiator is exclusively in the form of a component incorporated into the poly(meth)acrylate by polymerization. However, a combination of these two embodiments is also possible. The photoinitiator may be selected for example from so-called a-splitters, i.e. photoinitiators, in which a chemical compound is split to form 2 radicals which initiate the further crosslinking or polymerization reactions. These include for example acylphosphine oxides (Lucirin® line from BASF), hydroxyalkylphenones (for example Irgacure® 184), benzoin derivatives, benzil derivatives, dialkyloxyacetophenones. They may especially be so-called H-abstractors which detach a hydrogen atom from the polymer chain, for example photoinitiators having a carbonyl group. This carbonyl group inserts itself into a C—H bond to form a C—C—O—H moiety. Examples include in particular acetophenone, benzophenone and derivatives thereof. Both classes of photoinitiators may be used alone or else in admixture. It is particularly preferable when a photoinitiator incorporated into the polymer chain by free-radical copolymerization is concerned. The photoinitiator preferably comprises an acryloyl or (meth)acryloyl group to this end.

Photoinitiators that may be added to the copolymer as an additive are, for example, acetophenone, benzoin ether, benzyl dialkyl ketals or derivatives thereof. The content of the added photoinitiator is preferably 0.05 to 10 parts by weight, particularly preferably 0.1 to 5 parts by weight per 100 parts by weight of the copolymer.

By irradiation with high-energy light, in particular UV light, the photoinitiator or the photoinitiator group brings about crosslinking of the polymer, preferably by means of a chemical grafting reaction of the photoinitiator group with a spatially adjacent polymer or oligomer chain. The crosslinking may in particular be effected by insertion of a carbonyl group of the photoinitiator into an adjacent C—H bond to form a-C—C—O—H moiety. The wavelength range in which the photoinitiator group may be activated, i.e. which comprises the primary absorption bands of the photoinitiator group, is preferably 200 to 450 nm, particularly preferably 250 to 350 nm, very particularly preferably 250 to 280 nm.

The photoinitiator may be incorporated into the copolymer by polymerization. The copolymer may be produced by free radical polymerization of the desired monomers with co-polymerization of at least one radiation-sensitive, free-radically polymerizable organic compound. Radiation-sensitive, free-radically polymerizable organic compounds are hereinbelow referred to as polymerizable photoinitiator for short. The polymerizable photoinitiator may be incorporated into the polymer chain of copolymers by free radical copolymerization. Polymerizable photoinitiators preferably have the following principle structure:

A-X—B

wherein A is a monovalent organic radical which preferably comprises a phenone group as the radiation-sensitive group, X is an ester group selected from —O—C(═O)—, —(C═O)—O— and —O—(C═O)—O— and B is a monovalent organic radical comprising an ethylenically unsaturated free-radically polymerizable group. Preferred radicals A are radicals comprising at least one structural element derived from phenones, in particular from acetophenones or benzophenones. Preferred radicals B comprise at least one, preferably precisely one, acrylic or methacrylic group.

An ethylenically unsaturated group may be directly bonded to group X. The radiation-sensitive group may likewise be directly bonded to the group X. However, there may also be a spacer group between the ethylenically unsaturated group and the group X and between the radiation-sensitive group and group X respectively. The spacer group may have a molecular weight of up to 500, in particular up to 300 or 200, g/mol for example.

Suitable copolymerizable photoinitiators are acetophenone or benzophenone derivatives which comprise at least one, preferably one, ethylenically unsaturated group as described for example in EP 0377191 or EP 1213306. The ethylenically unsaturated group is preferably an acryloyl or methacryloyl group. The ethylenically unsaturated group may be directly bonded to the phenyl ring of the acetophenone or benzophenone derivative. There is generally a spacer group between the phenyl ring and the ethylenically unsaturated group. The spacer group may comprise for example up to 100 carbon atoms.

A preferred group X is the carbonate group —O—(C═O)—O—. Preferred polymerizable photoinitiators are compounds of formula F-1:

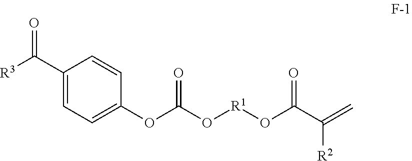

wherein R¹ represents an organic radical having up to 30 carbon atoms, R² represents an H atom or a methyl group and R³ represents a substituted or unsubstituted phenyl group or a C₁-C₄-alkyl group. R¹ particularly preferably represents an alkylene group, in particular a C₂-C₈-alkylene group. R³ particularly preferably represents a methyl group or a phenyl group, very particularly preferably a phenyl group.

Further acetophenone and benzophenone derivatives suitable as copolymerizable photoinitiators are, for example, those of formula F-2:

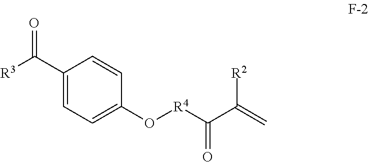

wherein R² and R³ are as defined above and R⁴ may represent a single bond or (—CH₂-CH₂—O)n, wherein n represents an integer from 1 to 12.

Further suitable photoinitiators may be found in U.S. Pat. No. 8,735,506, for example.

The hot melt adhesive preferably comprises 0.0001 to 0.5 mol, particularly preferably 0.0002 to 0.1 mol, very particularly preferably 0.003 to 0.01 mol, of the photoinitiator or of the molecular group active as a photoinitiator and bound to the polymer per 100 g of copolymer.

In the case of the photoinitiator incorporated by polymerization the copolymer is preferably formed to an extent of not less than 0.5% by weight, preferably not less than 1% by weight, for example from 0.5% to 10% by weight, from 1% to 5% by weight or from 1% to 4% by weight, from at least one ethylenically unsaturated, copolymerizable compound having a photoinitiator group.

### Water-borne Latex Adhesive

Optionally, a water-borne latex adhesive may be included in the composition. A suitable water-borne latex adhesive displays high initial tack, good performance at low temperatures, high water resistance, and high durability. The water-borne latex adhesive may be substantially free of organic solvents. The water-borne latex adhesive may be comprised of at least one styrene/acrylic latex or acrylic latex. The water-borne latex adhesive may further comprise one or more photoinitiators, as described above.

The at least one styrene/acrylic latex or acrylic latex may include a plurality of polymer particles. The particles can have a particle size distribution range, as determined by static light scattering, dynamic light scattering, capillary hydrodynamic fractionation or microscope image analysis. For example, the methods described in ASTM E3247-20 and reported as volume average particle size, no greater than 5,000 nm, no greater than 4,000 nm, no greater than 3,000 nm, no greater than 2,000 nm, no greater than 1,000 nm, no greater than 750 nm, no greater than 500 nm, no greater than 400 nm, no greater than 300 nm, no greater than 200 nm, or no greater than 100 nm. In some embodiments, the particles have a particle size from 10-5,000 nm, from 10-4,000 nm, from 10-3,000 nm, from 10-2,000 nm, from 10-1,000 nm, from 10-750 nm, from 10-500 nm, from 10-400 nm, from 10-300 nm, from 10-200 nm, from 10-100 nm, from 10-50 nm, from 50-5,000 nm, from 50-4,000 nm, from 50-3,000 nm, from 50-2,000 nm, from 50-1,000 nm, from 50-750 nm, from 50-500 nm, from 50-400 nm, from 50-300 nm, from 50-200 nm, from 50-100 nm, from 100-1,000 nm, from 100-750 nm, from 100-500 nm, from 100-400 nm, from 100-300 nm, or from 100-200 nm.

In some embodiments, the particles have a particle size from 20-400 nm. In some embodiments, the particles have a particle size from 30˜300 nm.

The particles can be prepared by polymerizing a monomer mixture emulsified in water, for instance by emulsion polymerization, optionally in the presence of a polymeric seed. Alternatively, the latex may be prepared by direct emulsification by heating and dissolving one or more solid polymers and dispersing the dissolved polymers in water gradually with the aid of surfactant or dispersing agent. In some embodiments, the particles can include at least two different copolymers (a multi-stage copolymer), e.g., a styrene/acrylic copolymer, an acrylic polymer, a second copolymer, a third copolymer, etc. In some embodiments, the styrene/acrylic copolymer polymer or acrylic polymer, second copolymer, etc. can be prepared in separate reaction vessels, and then combined. In preferred embodiments, the second copolymer, third copolymer, etc. is prepared by polymerizing a monomer mixture in the presence of the styrene/acrylic copolymer or the acrylic polymer.

The styrene/acrylic copolymers and acrylic polymers may be derived from at least one monomer selected from the group consisting of styrene, methyl acrylate, methyl methacrylate, ethyl acrylate, ethyl methacrylate, butyl acrylate, butyl methacrylate, 2-ethylhexyl acrylate, 2-ethylhexyl methacrylate, isobutyl (meth)acrylate, n-hexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl (meth)acrylate, tridecyl (meth)acrylate, stearyl (meth)acrylate, glycidyl (meth)acrylate, alkyl crotonates, vinyl acetate, di-n-butyl maleate, di-octylmaleate, hydroxyethyl (meth)acrylate, allyl (meth)acrylate, tetrahydrofurfuryl (meth)acrylate, cyclohexyl (meth)acrylate, 2-ethoxyethyl (meth)acrylate, 2-methoxy (meth)acrylate, 2-(2-ethoxyethoxy)ethyl (meth)acrylate, 2-propylheptyl (meth)acrylate, 2-phenoxyethyl (meth)acrylate, isobornyl (meth)acrylate, caprolactone (meth)acrylate, polypropyleneglycol mono (meth)acrylate, polyethyleneglycol (meth)acrylate, benzyl (meth)acrylate, hydroxypropyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate, acrylic acid, methacrylic acid, itaconic acid, crotonic acid, fumaric acid, maleic acid, maleic anhydride, n-butylmaleic monoesters, monoethyl fumarate, monomethyl itaconate and monomethyl maleate, acrylamide and methacrylamide, N-methyl acrylamide and -methacrylamide, N-methylolacrylamide and -methacrylamide, maleic acid monoamide and diamide, itaconic acid monoamide and diamide, fumaric acid monoamide and diamide, vinylsulfonic acid, and vinylphosphonic acid.

The styrene/acrylic latex or acrylic latex may further include a crosslinkable monomers such as diacetone acrylamide and its derivatives, and 2-(methacryloyloxy)ethyl acetoacetate and its derivatives.

Preferably, the styrene/acrylic latex or acrylic may be derived from at least one monomer selected from styrene, 2-ethylhexyl acrylate, methyl acrylate, methyl methacrylate, ethyl acrylate, ethyl methacrylate, butyl acrylate, butyl methacrylate, acrylamide, acrylic acid, methacrylic acid, itaconic acid, and vinylphosphonic acid, diacetone acrylamide and 2-(methacryloyloxy ethyl acetoacetate.

The styrene/acrylic latex or acrylic latex may further include a crosslinking agent that can react with the crosslinkable monomers described above. The crosslinking agent may include adipic dihydrazide (ADDH); multifunctional amines; and metal ions, such as copper, magnesium, zinc, calcium, iron, chromium, titanium, aluminum, and zirconium, for example. Preferrably, the metal ions are zinc, aluminum or zirconium.

In some embodiments, the glass transition temperature (Tg) of the styrene/acrylic latex or acrylic latex can range from −60° C. to 30° C. For example, the Tg may be −40° C. or greater, −35° C. or greater, −30° C. or greater, −25° C. or greater, −20° C. or greater, −15° C. or greater, −10° C. or less, −5° C. or less, 0° C. or less, 5° C. or less, or 10° C. or less. The glass transition temperature can be determined by differential scanning calorimetry (DSC) by measuring the midpoint temperature using ASTM D 3418-12e1.

The Tg of the styrene/acrylic latex or acrylic latex can be between any of the values described above. For example, the Tg can range from −60° C. to 30° C. (e.g., from 0° C. to 5° C., from 0° C. to 5° C., from −10° C. to −30° C., or from −20° C. to −40° C., for example).

The styrene/acrylic latex or acrylic latex may include a soft phase. The glass transition temperature (Tg) of the soft phase may be 20° C. or less, 15° C. or less, 10° C. or less, 5° C. or less, 0° C. or less, −5° C. or less, or −10° C. or less.

The Tg of the soft phase of the polymer may be calculated by the Flory-Fox equation, shown below, wherein Tg is the glass transition temperature, Tg,∞ is the maximum glass transition temperature that can be achieved at a theoretical infinite molecular weight, Mₙ is the number average molecular weight of the polymer, and K is an empirical parameter related to the free volume present in the polymer sample.

$${T}_{g} = {T}_{g , ∞} - K / {M}_{n}$$

The acrylate component of the styrene/acrylic latex or acrylic latex can be derived from one or more soft ethylenically-unsaturated monomers. As used herein, the term “soft ethylenically-unsaturated monomer” refers to an ethylenically-unsaturated monomer that, when homopolymerized, forms a polymer having a glass transition temperature, as measured using differential scanning calorimetry (DSC), of 20° C. or less. Soft ethylenically-unsaturated monomers are known in the art, and include, for example, methyl acrylate (Tg=10° C.), ethyl acrylate (Tg=−24° C.), n-butyl acrylate, (Tg=−54° C.), sec-butyl acrylate (Tg=−26° C.), n-hexyl acrylate (Tg=−45° C.), n-hexyl methacrylate (Tg=−5° C.), 2-ethylhexyl acrylate (Tg=−85° C.), 2-ethylhexyl methacrylate (Tg=−10° C.), octyl methacrylate (Tg=−20° C.), n-decyl methacrylate (Tg=−30° C.), isodecyl acrylate (Tg=−55° C.), dodecyl acrylate (Tg=−3° C.), dodecyl methacrylate (Tg=−65° C.), 2-ethoxyethyl acrylate (Tg=−50° C.), 2-methoxy acrylate (Tg=−50° C.), and 2-(2-ethoxyethoxy)ethyl acrylate (Tg=−70° C.).

In some embodiments, soft phase can include a soft ethylenically-unsaturated monomer that, when homopolymerized, forms a polymer having a glass transition temperature, as measured using DSC, of 20° C. or less (e.g., 20° C. or less, 10° C. or less, 0° C. or less, −10° C. or less, −20° C. or less, −30° C. or less, −40° C. or less, −50° C. or less, −60° C. or less, −70° C. or less, or -80° C. or less). In certain embodiments, the soft ethylenically-unsaturated monomer can be a (meth)acrylate monomer. In certain embodiments, the acrylate component of the styrene/acrylic latex or acrylic latex can be derived from a soft ethylenically-unsaturated monomer selected from the group consisting of n-butyl acrylate, ethyl acrylate, sec-butyl acrylate, 2-ethylhexyl (meth)acrylate, and combinations thereof.

In some embodiments, soft phase can include a hard ethylenically-unsaturated monomer that, when homopolymerized, forms a polymer having a glass transition temperature, as measured using DSC, of 20° C. or less (e.g., 20° C. or less, 10° C. or less, 0° C. or less, −10° C. or less, −20° C. or less, −30° C. or less, −40° C. or less, −50° C. or less, −60° C. or less, −70° C. or less, or −80° C. or less). Hard ethylenically-unsaturated monomers are known in the art, and include, for example, methyl methacrylate (Tg=105° C.), ethyl methacrylate (Tg=65° C.), n-butyl methacrylate (Tg=20° C.), tert-butyl methacrylate (Tg=118° C.), tert-butyl acrylate (Tg=45° C.), isobutyl methacrylate (Tg=53° C.), vinyl acetate (Tg=30° C.), hydroxyethyl acrylate (Tg=15° C.), hydroxyethyl methacrylate (Tg=57° C.), cyclohexyl acrylate (Tg=19° C.), cyclohexyl methacrylate (Tg=92° C.), 2-ethoxyethyl methacrylate (Tg=16° C.), 2-phenoxyethyl methacrylate (Tg=54° C.), benzyl acrylate (Tg=6° C.), benzyl methacrylate (Tg=54° C.), hydroxypropyl methacrylate (Tg=76° C.), styrene (Tg=100° C.), 4-acetostyrene (Tg=116° C.), acrylamide (Tg=165° C.), acrylonitrile (Tg=125° C.), 4-bromostyrene (Tg=118° C.), n-tert-butylacrylamide (Tg=128° C.), 4-tert-butylstyrene (Tg=127° C.), 2,4-dimethylstyrene (Tg=112° C.), 2,5-dimethylstyrene (Tg=143° C.), 3,5-dimethylstyrene (Tg=104° C.), isobornyl acrylate (Tg=94° C.), isobornyl methacrylate (Tg=110° C.), 4-methoxystyrene (Tg=113° C.), methylstyrene (Tg=20° C.), 4-methylstyrene (Tg=97° C.), 3-methylstyrene (Tg=97° C.), 2,4,6-trimethylstyrene (Tg=162° C.), and combinations thereof.

In some embodiments, soft phase can include a soft ethylenically-unsaturated monomer and a hard ethylenically-unsaturated monomer that, when copolymerized, forms a polymer having a glass transition temperature, as measured using DSC, of 20° C. or less (e.g., 20° C. or less, 10° C. or less, 0° C. or less, −10° C. or less, −20° C. or less, −30° C. or less, −40° C. or less, −50° C. or less, −60° C. or less, −70° C. or less, or −80° C. or less).

The styrene/acrylic latex or acrylic latex can be derived from at least 10% to at most 95% by weight of one or more soft ethylenically-unsaturated monomers, based on the total weight of the monomers used to form the styrene/acrylic latex or acrylic latex (e.g., at least 15% by weight, at least 20% by weight, at least 25% by weight, at least 30% by weight, at least 35% by weight, at least 40% by weight, at least 45% by weight, at least 50% by weight, at least 55% by weight, at least 60% by weight, at least 65% by weight, at least 70% by weight, at least 75% by weight, at least 80% by weight, at least 85% by weight, or at least 90% by weight). The styrene/acrylic latex or acrylic latex can be derived from at most 95% by weight of one or more soft ethylenically-unsaturated monomers, based on the total weight of the monomers used to form the styrene/acrylic latex or acrylic latex (e.g., at most 90% by weight, at most 80% by weight at most 80% by weight, at most 75% by weight, at most 70% by weight, at most 65% by weight, at most 60% by weight, at most 55% by weight, at most 50% by weight, at most 45% by weight, at most 40% by weight, at most 35% by weight, at most 30% by weight, at most 25% by weight, at most 20% by weight, or at most 15% by weight).

The styrene/acrylic latex or acrylic latex can be derived from an amount of one or more soft ethylenically-unsaturated monomers ranging from any of the minimum percentages described above to any of the maximum percentages described above. For example, the styrene/acrylic latex or acrylic latex can be derived from 15% to 95% by weight of one or more soft ethylenically-unsaturated monomers, based on the total weight of the monomers used to form the styrene/acrylic latex or acrylic latex (e.g., from 15% to 85% by weight, from 25% to 80% by weight, from 30% to 70% by weight, or from 35% to 55% by weight). Preferably, the styrene/acrylic latex or acrylic latex can be derived from about 40% to about 95% by weight of one or more soft ethylenically-unsaturated monomers, based on the total weight of the monomers used to form the styrene/acrylic latex or acrylic latex.

Optionally, the styrene/acrylic latex or acrylic latex may contain a hard phase. The hard phase of the styrene/acrylic latex or acrylic latex may have a glass transition temperature (Tg), as calculated by the Flory-Fox equation, higher than the Tg of the soft phase. The Tg of the hard phase of the styrene/acrylic latex or acrylic latex may be 20° C. higher than that of the soft phase, for example.

The hard phase can include one or more hard ethylenically-unsaturated monomers. As used herein, the term “hard ethylenically-unsaturated monomer” refers to an ethylenically-unsaturated monomer that, when homopolymerized, forms a polymer having a Tg, as measured using DSC, of greater than 20° C. Hard ethylenically-unsaturated monomers are known in the art, and include, for example,, methyl methacrylate (Tg=105° C.), ethyl methacrylate (Tg=65° C.), n-butyl methacrylate (Tg=20° C.), tert-butyl methacrylate (Tg=118° C.), tert-butyl acrylate (Tg=45° C.), isobutyl methacrylate (Tg=53° C.), vinyl acetate (Tg=30° C.), hydroxyethyl acrylate (Tg=15° C.), hydroxyethyl methacrylate (Tg=57° C.), cyclohexyl acrylate (Tg=19° C.), cyclohexyl methacrylate (Tg=92° C.), 2-ethoxyethyl methacrylate (Tg=16° C.), 2-phenoxyethyl methacrylate (Tg=54° C.), benzyl acrylate (Tg=6° C.), benzyl methacrylate (Tg=54° C.), hydroxypropyl methacrylate (Tg=76° C.), styrene (Tg=100° C.), 4-acetostyrene (Tg=116° C.), acrylamide (Tg=165° C.), acrylonitrile (Tg=125° C.), 4-bromostyrene (Tg=118° C.), n-tert-butylacrylamide (Tg=128° C.), 4-tert-butylstyrene (Tg=127° C.), 2,4-dimethylstyrene (Tg=112° C.), 2,5-dimethylstyrene (Tg=143° C.), 3,5-dimethylstyrene (Tg=104° C.), isobornyl acrylate (Tg=94° C.), isobornyl methacrylate (Tg=110° C.), 4-methoxystyrene (Tg=113° C.), methylstyrene (Tg=20° C.), 4-methylstyrene (Tg=97° C.), 3-methylstyrene (Tg=97° C.), 2,4,6-trimethylstyrene (Tg=162° C.), and combinations thereof.

In some embodiments, hard phase can include a soft ethylenically-unsaturated monomer that, when homopolymerized, forms a polymer having a glass transition temperature, as measured using DSC, of 20° C. or less (e.g., 20° C. or less, 10° C. or less, 0° C. or less, −10° C. or less, −20° C. or less, −30° C. or less, −40° C. or less, −50° C. or less, −60° C. or less, −70° C. or less, or −80° C. or less).

In some embodiments, hard phase can include a soft ethylenically-unsaturated monomer and a hard ethylenically-unsaturated monomer that, when copolymerized, forms a polymer having a glass transition temperature higher than the Tg of the soft phase. The Tg of the hard phase of the styrene/acrylic latex or acrylic latex may be 20° C. higher than that of the soft phase, for example.

In some embodiments, the styrene/acrylic latex or acrylic latex can be derived from greater than 5% by weight of one or more hard ethylenically-unsaturated monomers (e.g., 10% by weight or greater, 20% by weight or greater, 30% by weight or greater, 40% by weight or greater, 50% by weight or greater, 55% by weight or greater of the hard ethylenically-unsaturated monomer) based on the total weight of monomers used to form the styrene/acrylic latex or acrylic latex.

In some embodiments, the styrene/acrylic latex or acrylic latex can be derived from less than 60% by weight of one or more hard ethylenically-unsaturated monomers (e.g., 55% or less by weight,50% or less by weight, 45% or less by weight, 40% or less by weight, 35% or less by weight, 30% or less by weight, 25% or less by weight, 20% or less by weight, 15% or less by weight, 10% or less by weight) based on the total weight of monomers used to form the styrene/acrylic latex or acrylic latex.

The styrene/acrylic latex or acrylic latex can be derived from one or more additional ethylenically-unsaturated monomers (e.g., (meth)acrylate monomers, vinyl aromatic monomers, etc.) as described below in addition to one or more soft ethylenically-unsaturated monomers, one or more phosphorus-containing monomers, and one or more acetoacetoxy monomers, keto or aldehyde monomers.

The styrene/acrylic latex or acrylic latex can be derived from greater than 0% by weight to 55% by weight of one or more additional ethylenically-unsaturated monomers. Additional ethylenically unsaturated monomers include (meth)acrylate monomers. These meth (acrylate) monomers include esters of α,β-monoethylenically unsaturated monocarboxylic and dicarboxylic acids having 3 to 6 carbon atoms with alkanols having 1 to 20 carbon atoms (e.g., esters of acrylic acid, methacrylic acid, maleic acid, fumaric acid, or itaconic acid, with C1-C20, C1-C12, C1-C8, or C1-C4 alkanols). Exemplary acrylate and methacrylate monomers include, but are not limited to, methyl (meth)acrylate, ethyl (meth)acrylate, n-butyl (meth)acrylate, iso-butyl (meth)acrylate, t-butyl (meth)acrylate, 2-ethylhexyl (meth)acrylate, n-hexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl (meth)acrylate, tridecyl (meth)acrylate, stearyl (meth)acrylate, glycidyl (meth)acrylate, alkyl crotonates, vinyl acetate, di-n-butyl maleate, di-octylmaleate, hydroxyethyl (meth)acrylate, allyl (meth)acrylate, tetrahydrofurfuryl (meth)acrylate, cyclohexyl (meth)acrylate, 2-ethoxyethyl (meth)acrylate, 2-methoxy (meth)acrylate, 2-(2-ethoxyethoxy) ethyl (meth)acrylate, 2-propylheptyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, hydroxypropyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate, trimethylolpropane tri(meth)acrylate, pentaerythritol tetra(meth)acrylate and combinations thereof. In some embodiments, the acrylate component of the styrene/acrylic latex or acrylic latex comprises one or more (meth)acrylate monomers selected from the group consisting of methyl methacrylate, n-butyl acrylate, 2-ethylhexylacrylate, and combinations thereof. In some embodiments, the acrylate component of the styrene/acrylic latex or acrylic latex comprises methyl methacrylate and n-butyl acrylate.

In the styrene/acrylic latex or acrylic latex, additional ethylenically unsaturated monomers may include a vinyl aromatic having up to 20 carbon atoms, a vinyl ester of a carboxylic acid comprising up to 20 carbon atoms, a (meth) acrylonitrile, a vinyl halide, a vinyl ether of an alcohol comprising 1 to 10 carbon atoms, an aliphatic hydrocarbon having 2 to 8 carbon atoms and one or two double bonds, a alkoxy silane-containing monomer, a (meth) acrylamide, adhesion promoting ureido functional (meth)acrylate monomer, a (meth) acrylamide derivative, a sulfur-based monomer, or a combination of these monomers.

Suitable vinyl aromatic compounds include styrene, a-and p-methylstyrene, α-butylstyrene, 4-n-butylstyrene, 4-n-decylstyrene, vinyltoluene, and combinations thereof. Vinyl esters of carboxylic acids with alkanols having up to 20 carbon atoms include, for example, vinyl laurate, vinyl stearate, vinyl propionate, versatic acid vinyl esters, vinyl acetate, and combinations thereof. The vinyl halides can include ethylenically unsaturated compounds substituted by chlorine, fluorine or bromine, such as vinyl chloride and vinylidene chloride. The vinyl ethers can include, for example, vinyl ethers of alcohols comprising 1 to 4 carbon atoms, such as vinyl methyl ether or vinyl isobutyl ether. Aliphatic hydrocarbons having 2 to 8 carbon atoms and one or two double bonds can include, for example, hydrocarbons having 4 to 8 carbon atoms and two olefinic double bonds, such as butadiene, isoprene, and chloroprene. Alkoxy silane containing monomers can include, for example, vinyl silanes, such as vinyltrimethoxysilane, vinyltriethoxysilane (VTEO), vinyl tris(2-methoxyethoxysilane), and vinyl triisopropoxysilane, and (meth)acrylalkoxysilanes, such as (meth)acryloyloxypropyltrimethoxysilane, γ-(meth)acryloxypropyltrimethoxysilane, and γ-(meth)acryloxypropyltriethoxysilane. Sulfur-containing monomers include, for example, sulfonic acids and sulfonates, such as vinylsulfonic acid, 2-sulfoethyl methacrylate, sodium styrenesulfonate, 2-sulfoxyethyl methacrylate, vinyl butylsulfonate, sulfones such as vinylsulfone, sulfoxides such as vinylsulfoxide, and sulfides such as 1-(2-hydroxyethylthio) butadiene. When present, the sulfur-containing monomers are generally present in an amount greater than 0% by weight to 5% by weight.

The styrene/acrylic latex or acrylic latex may include an acrylic-based copolymer. Acrylic-based copolymers include copolymers derived from one or more (meth)acrylate monomers. The acrylic-based copolymer can be a pure acrylic polymer (i.e., a copolymer derived primarily from (meth)acrylate monomers), a styrene-acrylic polymer (i.e., a copolymer derived from styrene and one or more (meth)acrylate monomers), or a vinyl-acrylic polymer (i.e., a copolymer derived from one or more vinyl ester monomers and one or more (meth)acrylate monomers).

The styrene/acrylic latex or acrylic latex can be derived from one or more phosphorous acid-containing monomers based on the total weight of monomers. Ammonium, alkali metal ion, alkaline earth metal ion and other metal ion salts of these acids can also be used. Suitable phosphorus-containing monomers are vinylphosphonic acid and allylphosphonic acid, for example. Also suitable are the monoesters and diesters of phosphonic acid and phosphoric acid with hydroxyalkyl(meth)acrylates, especially the monoesters. Additionally suitable monomers are diesters of phosphonic acid and phosphoric acid that have been esterified once with hydroxyalkyl(meth)acrylate and also once with a different alcohol, such as an alkanol, for example. Suitable hydroxyalkyl(meth)acrylates for these esters are those specified below as separate monomers, more particularly 2-hydroxyethyl(meth)acrylate, 3-hydroxypropyl(meth)acrylate, 4-hydroxybutyl(meth)acrylate, etc. Corresponding dihydrogen phosphate ester monomers comprise phosphoalkyl(meth)acrylates, such as 2-phosphoethyl(meth)acrylate, 2-phosphopropyl(meth)acrylate, 3-phosphopropyl(meth)acrylate, phosphobutyl(meth)acrylate, and 3-phospho-2-hydroxypropyl(meth)acrylate. Also suitable are the esters of phosphonic acid and phosphoric acid with alkoxylated hydroxyalkyl(meth)acrylates, examples being the ethylene oxide or propylene oxide condensates of (meth)acrylates, such as H₂C═C(CH₃)COO(CH₂CH₂O)ₙP(OH)₂ and H₂C═C(CH₃)COO(CH₂CH₂₀)ₙP(═O)(OH)₂, in which n is 1 to 50. Of further suitability are phosphoalkyl crotonates, phosphoalkyl maleates, phosphoalkyl fumarates, phosphodialkyl(meth)acrylates, phosphodialkyl crotonates and allyl phosphates.

Examples of phosphate containing unsaturated monomers are Sipomer® PAM 4000 or Sipomer® PAM 200, distributed, by, for example, Solvay. Alkali or alkaline earth metal ion or ammonia neutralized salts of the above acids and combinations thereof can also be used. In some instances, the monomer mixture can include a mixture of ethylenically unsaturated acids, for instance (meth) acrylic acid and phosphorous acid containing monomers, or itaconic acid and phosphorous acid containing monomers or combination of carboxylic and phosphorous acid containing monomers. Alkali or alkaline earth metal ion or ammonia neutralized salts of the above acids and combinations thereof can also be used.

The styrene/acrylic latex or acrylic latex can be derived from greater than 0% by weight of one or more phosphorus-containing monomers, based on the total weight of the monomers used to form the styrene/acrylic latex or acrylic latex (e.g., at least 0.25% by weight, at least 0.5% by weight, at least 1% by weight, at least 1.5% by weight, at least 2% by weight, at least 2.5% by weight, at least 3% by weight, at least 3.5% by weight, at least 4% by weight, or at least 4.5% by weight or at least 5% by weight or at least 10% by weight). The styrene/acrylic latex or acrylic latex can be derived from 10% or less by weight of one or more phosphorus-containing monomers, based on the total weight of the monomers used to form the styrene/acrylic latex or acrylic latex (e.g., from 5% or less by weight, from 4.5% or less by weight, from 4% or less by weight, from 3.5% or less by weight, from 3% or less by weight, from 2.5% or less by weight, from 2% or less by weight, from 1.5% or less by weight, from 1% or less by weight, or from 0.5% or less by weight, or from 0.25% or less by weight).

The styrene/acrylic latex or acrylic latex can be derived from greater than 0% by weight of one or more acid-containing monomers, based on the total weight of the monomers used to form the styrene/acrylic latex or acrylic latex (e.g., at least 0.5% by weight, at least 1% by weight, at least 2% by weight, at least 3% by weight, at least 4% by weight, at least 5% by weight, at least 6% by weight, at least 7% by weight, at least 8% by weight, at least 9% by weight at least 10% by weight, at least 15% by weight, at least 20% by weight, at least 25% by weight, at least 30% by weight). The styrene/acrylic latex or acrylic latex can be derived from 30% or less by weight of one or more acid-containing monomers, based on the total weight of the monomers used to form the second copolymer (e.g., from 25% or less by weight, from 20% or less by weight, from 15% or less by weight, from 10% or less by weight, from 5% or less by weight, from 3% or less by weight, or from 1% or less by weight). Preferably, the styrene/acrylic latex or acrylic latex can be derived from about 0.5% to about 10% by weight of one or more acid-containing monomers, based on the total weight of the monomers used to form styrene/acrylic latex or acrylic latex.

The styrene/acrylic latex or acrylic latex can be derived from one or more carboxylic acid-containing monomers. Suitable carboxylic acid-containing monomers are known in the art, and include α,β-monoethylenically unsaturated mono-and dicarboxylic acids, such as acrylic acid, methacrylic acid, itaconic acid, crotonic acid, maleic acid, fumaric acid, dimethacrylic acid, ethylacrylic acid, allylacetic acid, vinylacetic acid, mesaconic acid, methylenemalonic acid, citraconic acid, and combinations thereof.

The styrene/acrylic latex or acrylic latex can be derived from an amount of one or more acid-containing monomers ranging from any of the minimum percentages described above to any of the maximum percentages described above. For example, the styrene/acrylic latex or acrylic latex can be derived from greater than 0.5% by weight to 30% by weight of one or more acid-containing monomers, based on the total weight of the monomers used to form the styrene/acrylic latex or acrylic latex (e.g., from greater than 2% by weight to 20% by weight of one or more acid-containing monomers). In certain embodiments, the styrene/acrylic latex or acrylic latex is derived from greater than 2% by weight to 30% by weight (e.g., greater than 2% by weight to 10% by weight, greater than 2% by weight to 15% by weight, or greater than 2% by weight to 20% by weight) acid monomers.

The styrene/acrylic latex or acrylic latex can be derived from one or more sulfur acid-containing monomers. Suitable sulfur acid monomers are vinylsulfonic acid, allylsulfonic acid, sulfoethyl acrylate, sulfoethyl methacrylate, sulfopropyl acrylate, sulfopropyl methacrylate, 2-hydroxy-3-acryloyloxypropylsulfonic acid, 2-hydroxy-3-methacryloyloxypropylsulfonic acid, styrenesulfonic acids, 2-acrylamido-2-methylpropanesulfonic acid and their ionic salts with ammonium and metal ions. Suitable styrenesulfonic acids and derivatives thereof are styrene-4-sulfonic acid and styrene-3-sulfonic acid, and their ionic salt with metal ions, such as sodium styrene-3-sulfonate and sodium styrene-4-sulfonate.

The styrene/acrylic latex or acrylic latex can be derived from an amount of one or more phosphorus-containing monomers ranging from any of the minimum percentages described above to any of the maximum percentages described above. For example, the styrene/acrylic latex or acrylic latex can be derived from greater than 0% by weight to 10% by weight of one or more phosphorus-containing monomers, based on the total weight of the monomers used to form the styrene/acrylic latex or acrylic latex (e.g., from greater than 0% by weight to 5% by weight of one or more phosphorus-containing monomers or from greater than 0% by weight to 2.5% by weight of one or more phosphorus-containing monomers). In certain embodiments, the styrene/acrylic latex or acrylic latex is derived from greater than 0% by weight to 10% by weight (e.g., greater than 0% by weight to 5% by weight, greater than 0% by weight to 3% by weight, greater than 0% by weight to 2.5% by weight, or greater than 0% by weight to 1.5% by weight) 2-phosphoethyl methacrylate (PEM).

The styrene/acrylic latex or acrylic latex may further comprise one or more cross-linkable monomers, such as acrylamide monomers, methacrylate monomers, acetoacetoxy monomers, ketone monomers, aldehyde monomers, silane monomers, and combinations thereof. Suitable acetoacetoxy monomers are known in the art, and include acetoacetoxyalkyl (meth)acrylates, such as acetoacetoxyethyl (meth)acrylate (AAEM), acetoacetoxypropyl (meth)acrylate, acetoacetoxybutyl (meth)acrylate, and 2,3-di(acetoacetoxy)propyl (meth)acrylate; allyl acetoacetate; vinyl acetoacetate; and combinations thereof. Suitable keto monomers include diacetone acrylamide (DAAM). Keto monomers include keto-containing amide functional monomers defined by the general structure below

CH₂═CR¹C(O)NR²C(O)R³

wherein R¹ is hydrogen or methyl; R² is hydrogen, a C₁-C₄ alkyl group, or a phenyl group; and R³ is hydrogen, a C₁-C₄ alkyl group, or a phenyl group. For example, the (meth)acrylamide derivative can be diacetone acrylamide (DAAM) or diacetone methacrylamide. Suitable aldehyde monomers include (meth)acrolein.

The styrene/acrylic latex or acrylic latex can be derived from greater than 0% by weight of one or more acetoacetoxy, keto or aldehyde monomers, based on the total weight of the monomers used to form the styrene/acrylic latex or acrylic latex (e.g., at least 0.5% by weight, at least 1% by weight, at least 1.5% by weight, at least 2% by weight, at least 2.5% by weight, at least 3% by weight, at least 3.5% by weight, at least 4% by weight, at least 4.5% by weight, at least 5% by weight, at least 5.5% by weight, at least 6% by weight, at least 6.5% by weight, at least 7% by weight, at least 7.5% by weight, at least 8% by weight, at least 8.5% by weight, at least 9% by weight, at least 9.5% by weight, at least 10% by weight or at least 15% by weight). The styrene/acrylic latex or acrylic latex can be derived from 15% or less by weight of one or more acetoacetoxy, keto or aldehyde monomers, based on the total weight of the monomers used to form the styrene/acrylic latex or acrylic latex (e.g., from 10% or less by weight, from 9.5% or less by weight, from 8% or less by weight, from 8.5% or less by weight, from 8% or less by weight, from 7.5% or less by weight, from 7% or less by weight, from 6.5% or less by weight, from 6% or less by weight, from 5.5% or less by weight, from 5% or less by weight, from 4.5% or less by weight, from 4% or less by weight, from 3.5% or less by weight, from 3% or less by weight, from 2.5% or less by weight, from 2% or less by weight, from 1.5% or less by weight, from 1% or less by weight, or from 0.5% or less by weight).

Acetoacetoxy, keto or aldehyde groups can be reacted with polyamines to form crosslinks. Polyamines with primary amine groups are preferred. Examples of suitable polyfunctional amines include polyetheramines, polyalkyleneamines, polyhydrazides, or a combination thereof. Specific examples of polyfunctional amines include polyfunctional amines sold under the trade names, Baxxodur, Jeffamine, and Dytek. In some embodiments amines are difunctional or higher functional. Polyfunctional amine-terminated polyoxyalkylene polyols (e.g., Jeffamines or Baxxodur amines), examples being polyetheramine T403, polyetheramine D230, polyetheramine D400, polyetheramine D2000, or polyetheramine T5000). In some embodiments, amines include Dytek A, Dytek EP, Dytek HMD, Dytek BHMT, and Dytek DCH-99. In some embodiments, amines are polyhydrazides derived from alipahtic and aromatic polycarboxylic acids including adipic dihydrazide, succinic dihydrazide, citric trihydrazide, isophthalic dihydrazide, phthalic dihydrazide, or trimellitic trihydrazide. Other amines include diethylenetriamine, triethylenetetramine, tetraethylenepentamine, pentaethylenehexamine, hexaethyleneheptamine, heptaethyleneoctamine, 5 octaethylenenonamine, higher polyimines e.g., polyethyleneimines and polypropyleneimines, bis(3-aminopropyl) amine, bis(4-aminobutyl)amine, bis(4-5-aminopentyl)amine, bis(6-aminohexyl)amine, 3-(2-aminoethyl) aminopropylamine, N,N-bis(3-aminopropyl)ethylenediamine, N′,N-bis(3-aminopropyl) ethylenediamine, N,N-bis(3-aminopropyl)propane-1,3-diamine, N,N-bis(3-10 aminopropyl)butane-1,4-diamine, N,N′-bis(3-aminopropyl)propane-1,3-diamine, N,N′-bis(3-aminopropyl) butane-1,4-diamine, N,N,N′N′-tetra (3-aminopropyl)ethylenediamine, N,N,N′N′-tetra(3-aminopropyl)-1,4-butylenediamine, tris(2-aminoethyl)amine, tris(2-aminopropyl) amine, tris(3-aminopropyl)amine, tris (2-aminobutyl)amine, tris(3-aminobutyl)amine, tris(4-aminobutyl) amine, tris(5-aminopentyl)amine, tris(6-aminohexyl)amine, trisaminohexane, trisaminononane, 4-aminomethyl-1,8-octamethylenediamine. The preferred amines are polyhydrazides or adipic acid dihydrazide when diacetone acrylamide and its derivative monomer are used.

The acetoacetoxy, keto or aldehyde group to primary amine group ratio varies between 10:1 equivalents to 1:1.2 equivalents (e.g., 9:1 equivalents to 1:1.1 equivalents, 8:1 equivalents to 1:1 equivalents, 7:1 equivalents to 1:1 equivalents, 6:1 equivalents to 1:1 equivalents, 5:1 equivalents to 1:1 equivalents).

The styrene/acrylic latex or acrylic latex can be derived from an amount of one or more acetoacetoxy, keto or aldehyde monomers ranging from any of the minimum percentages described above to any of the maximum percentages described above. For example, the styrene/acrylic latex or acrylic latex can be derived from greater than 0% by weight to 10% by weight of one or more acetoacetoxy, keto or aldehyde monomers, based on the total weight of the monomers used to form the styrene/acrylic latex or acrylic latex (e.g., from 0.25% by weight to 10% by weight of one or more acetoacetoxy, keto or aldehyde monomers, from 0.5% by weight to 5% by weight of one or more acetoacetoxy, keto or aldehyde monomers, from 1% by weight to 7.5% by weight of one or more acetoacetoxy, keto or aldehyde monomers, from 2.5% by weight to 7.5% by weight of one or more acetoacetoxy, keto or aldehyde monomers, or from 5% by weight to 7.5% by weight of one or more acetoacetoxy, keto or aldehyde monomers). In certain embodiments, the styrene/acrylic latex or acrylic latex is derived from greater than 0% by weight to 10% by weight (e.g., from 1% by weight to 7.5% by weight, from 2.5% by weight to 7.5% by weight, or from 5% by weight to 7.5% by weight) acetoacetoxyethyl (meth)acrylate (AAEM). In certain embodiments, the styrene/acrylic latex or acrylic latex is derived from greater than 0% by weight to 10% by weight (e.g., from 0.25% by weight to 10% by weight, from 0.5% by weight to 5% by weight, from 1% by weight to 7.5% by weight, from 2.5% by weight to 7.5% by weight, or from 5% by weight to 7.5% by weight) of diacetone acrylamide (DAAM).

The molecular weight of the styrene/acrylic latex or acrylic latex may be described by its number average molecular weight (M_{w}). Weight average molecular weight may be determined using static light scattering, for example, and may be calculated as shown below, wherein Nᵢ is the number of molecules of molecular mass Mᵢ:

$${M}_{w} = {Σ}_{i} {N}_{i} {M}_{i}^{2} / {Σ}_{i} {N}_{i} {M}_{i}$$

The styrene/acrylic latex or acrylic latex described herein have a weight average molecular weight Mw of 20,000 Daltons or greater (e.g., 20,000 Daltons or greater, 30,000 Daltons or greater, 40,000 Daltons or greater, 50,000 Daltons or greater, 60,000 Daltons or greater, or 70,000 Daltons or greater, 80,000 Daltons or greater, 90,000 Daltons or greater, or 100,000 Daltons or greater).

The styrene/acrylic latex or acrylic latex described herein may have a gel content from about 0% to about 100%. The gel content of the styrene/acrylic latex or acrylic latex may be measured by dissolving the dry polymer in tetrahydrofuran (THF) and measuring the insoluble content. The ratio of the insoluble content to the total dry polymer may then be determined.

The styrene/acrylic latex or acrylic latex may have a gel content greater than 50% (e.g, 50% or greater, 60% or greater, 70% or greater, 80% or greater, 90% or greater, or 100%).

In some embodiments, the hot-melt adhesive, water-borne latex emulsion, and one or more additives are combined to form the pressure-sensitive adhesive layer. Exemplary additives include, but are not limited to, thickeners, wetting aids, defoamers, tackifiers, crosslinkers (e.g., metal salts, silane coupling agents such as glycidoxyalkyl alkoxylsilanes, or multifunctional acrylates such as trimethylolpropane triacrylate (TMPTA) or hexanediol diacrylate (HDDA)), fillers (e.g., calcium carbonate, fibers, carbon black, zinc oxide, titanium dioxide, chalk, solid or hollow glass beads, microbeads of other materials, silica, silicates), low-temperature plasticizers, nucleators, expandants, flow additives, fluorescent additives, polyolefins, rheology modifiers, surfactants, leveling additives, compounding agents and/or aging inhibitors in the form of primary and secondary antioxidants or in the form of light stabilizers, photoinitiators, pigments, dyes, or mixtures thereof. The coating can be applied to a surface and dried to produce a pressure-sensitive adhesive coating. The pressure sensitive adhesives disclosed herein can be produce strippable (temporary) or permanent adhesive bonds.

Exemplary tackifiers (tackifying resins) include, but are not limited to, natural resins, such as rosins and their derivatives formed by disproportionation or isomerization, polymerization, dimerization and/or hydrogenation. Tackifiers can include rosin and rosin derivatives (rosin esters, including rosin derivatives stabilized by, for example, disproportionation or hydrogenation) polyterpene resins, terpene-phenolic resins, alkylphenol resins, and aliphatic, aromatic and aliphatic-aromatic hydrocarbon resins, and combinations thereof. In some embodiments, the tackifying resins can be present in salt form (with, for example, monovalent or polyvalent counterions (cations)) or in esterified form. Alcohols used for the esterification can be monohydric or polyhydric. Exemplary alcohols include, but are not limited to, methanol, ethanediol, diethylene glycol, triethylene glycol, 1,2,3-propanethiol, and pentaerythritol.

Exemplary hydrocarbon tackifying resins include, but are not limited to, coumarone-indene resins, polyterpene resins, and hydrocarbon resins based on saturated CH compounds such as butadiene, pentene, methylbutene, isoprene, piperylene, divinylmethane, pentadiene, cyclopentene, cyclopentadiene, cyclohexadiene, styrene, α-methylstyrene, and vinyltoluene.

In some embodiments, the tackifying resins are derived from natural rosins. In some embodiments, the tackifying resin is selected from any resin that does not interfere with UV-curing (for instance, a resin that does not absorb so much UV radiation that it would prevent the PSA from curing satisfactorily). In some embodiments, the tackifying resins are chemically modified rosins. In some embodiments, the tackifying resins are fully hydrogenated. In some embodiments, the rosins comprise abietic acid or abietic acid derivatives. Exemplary commercially available tackifiers include, but are not limited to, FORAL® AX-E, FORAL® 85, and REGALRITE® 9100 by Eastman Chemical Company.

Exemplary crosslinkers include, but are not limited to, metal chelates, polyfunctional isocyanates, polyfunctional amines, polyfunctional alcohols, polyfunctional acrylates, and silane coupling agents such as glycidoxyalkyl alkoxylsilanes. A commercially available includes, but is not limited to, LAROMER® TMPTA (trimethylol propane triacrylate) by BASF.

Exemplary photointiators include any of the photoinitiators described above.

Dual cure

As described above, the compositions of the present disclosure may undergo both UV and thermal curing. In one embodiment, a coating may first undergo UV curing, followed by thermal cure. Alternatively, the coating may first be subjected to thermal cure, followed by UV curing. As yet another alternative, the UV and thermal cure processes may take place simultaneously. As yet a further alternative, the compositions may be cured by infrared (IR) exposure. For example, UV radiation of various wavelengths may provide secondary IR emission which may be utilized to cure the thermally curable component. Alternatively, IR radiation may be provided separately from UV exposure and thermal cure processes.

The coating composition may be applied and cured in a single layer. Alternatively, the coating composition may be applied and cured in successive layers until the desired thickness is reached.

The coating may have a thickness of about 0.5 mils (12.7 um) to about 30 mils (762 um), such as about 0.5 mils or greater, about 1 mil or greater, about 2 mils or greater, about 3 mils or greater, about 4 mils or greater, about 5 mils or greater, about 6 mils or greater, about 7 mils or greater, about 8 mils or greater, about 9 mils or greater, about 10 mils or greater, about 11 mils or greater, about 12 mils or greater, about 13 mils or greater, about 14 mils or greater, about 15 mils or less, about 16 mils or less, about 17 mils or less, about 18 mils or less, about 19 mils or less, about 20 mils or less, about 21 mils or less, about 22 mils or less, about 23 mils or less, about 24 mils or less, about 25 mils or less, about 26 mils or less, about 27 mils or less, about 28 mils or less, about 29 mils or less, about 30 mils or less or any value or range encompassed by these endpoints.

For example, the coating thickness may be between 1 mil (25.4 μm) and 4 mils (101.6 μm). Alternatively, the coating thickness may be between 5 mils (127 μm) and 20 mils (508 μm). As yet another alternative, the coating thickness may be between 20 mils and 30 mils.

The coating may be subjected to at least one UV curing step. Suitable UV light may include UVA, UVB, and UVC. In other words, the wavelength of the UV light may be about 100 nm or greater, about 150 nm or greater, about 200 nm or greater, about 250 nm or less about 300 nm or less, about 350 nm or less, about 400 nm or less, or any value encompassed by these endpoints. Preferably, the wavelength is about 260 nm.

The UV dose may be about 5 mJ/cm² or greater, about 10 mJ/cm² or greater, about 20 mJ/cm² or greater, about 50 mJ/cm² or greater, about 75 mJ/cm², about 100 mJ/cm² or greater, about 125 mJ/cm² or less, about 150 mJ cm² or less, about 175 mJ/cm² or less, about 200 mJ/cm² or less, about 225 mJ/cm² or less, about 250 mJ/cm² or less, about 275 mJ/cm² or less, about 300 mJ/cm² or less, or any value encompassed by these endpoints.

The coating may be subjected to multiple passes of UV curing. Alternatively, the coating may be subjected to one pass of UV curing. The coating may be subjected to multiple passes of UV curing at a lower dose, or the coating may be subjected to one pass of UV curing at a higher dose. For example, the coating may be subjected to one pass at a dose of about 300 mJ/cm². As a further example, the coating may be subjected to two doses at a dose of about 160 mJcm² each.

The coating may be subjected to a thermal curing step. The temperature during thermal curing may be 80° C. or higher, about may be 120° C. or higher, about 140° C. or higher, about 150° C. or higher, about 160° C. or higher, about 170° C. or higher, about 180° C. or higher, about 190° C. or higher, about 200° C. or higher, about 210° C. or higher, about 220° C. or higher, or any range or value encompassing these endpoints. For example, the temperature during the thermal curing step may be between 160° C. and 200° C.

During thermal curing, a temperature ramp may be used in which the temperature is raised over a period of time. The period of time may be about 1 minute or greater, about 2 minutes or greater, about 3 minutes or greater, about 4 minutes or greater, about 5 minutes or greater, about 6 minutes or greater, about 7 minutes or greater, about 8 minutes or less, about 9 minutes or less, about 10 minutes or less, about 11 minutes or less, about 12 minutes or less, about 13 minutes or less, about 14 minutes or less, about 15 minutes or less, or any value or range encompassing these endpoints.

The coating may be thermally cured for a total period of time of about 1 minute or greater, about 5 minutes or greater, about 10 minutes or greater, about 20 minutes or greater, about 30 minutes or greater, about 1 hour or greater, about 5 hours or greater, about 12 hours or less, about 18 hours or less, about 24 hours or less, about 36 hours or less, about 48 hours or less, or any value or range encompassed by these endpoints. For example, the coating may be thermally cured for a total period of time of upto about 60 minutes.

### Characteristics of the Coating

According to various embodiments described herein, the coating disposed on a surface of a membrane according to the present invention may be characterized by an advantageous peel strength.

In one or more embodiments, the layer of crosslinked pressure-sensitive adhesive disposed on a surface of the membrane according to the present invention may be characterized by an advantageous dead load shear.

### Coated Articles

The hot melt adhesives of the present disclosure may be applied directly to a substrate to form a coated article. Alternatively, the hot melt adhesives of the present disclosure may be applied to a release liner to form a multilayer composite. As yet another alternative, the hot melt adhesives of the present disclosure may be dissolved in a solvent and applied to a substrate as a liquid.

The multilayer composite may comprise: a polymeric membrane as described above; a layer comprising the hot melt composition of the present composition; and a release liner.

The multilayer composite may then be applied to a substrate to form a coated article.

The substrate may comprise nonwoven polypropylene, nonwoven polyethylene, nonwoven polyethylene terephthalate, woven polypropylene, woven polyethylene, spunbond polypropylene, spunbond polyester, and combinations thereof.

If the hot melt adhesive is dissolved in a solvent, suitable solvents may include hydrocarbons, alcohols such as methanol, ethanol, propanol, butanol, isobutanol, ketones such as acetone, methyl ethyl ketone, methyl isobutyl ketone, ethyl acetate, nitriles such as acetonitrile and benzonitrile or mixtures of any of the foregoing.

The coated article may be suitable for use in various applications, such as but not limited to roofing, construction, papers, tapes, and high temperature applications. The coated article may be suitable for use in exterior and interior applications.

### EXAMPLES

This example demonstrates the advantages and performance characteristics of the present invention.

### Examples

### Example 1

### Formulation Preparation

Six formulations were prepared and cured as shown below in Table 1. Each coating underwent UV curing followed by thermal cure.

TABLE 1

| | Formulation # | | | | | |
|---|---|---|---|---|---|---|
| | 1 | 2 | 3 | 4 | 5 | 6 |
| UV-curable | 97.5% | 97.5% | 97.5% | 100.0% | 100.0% | 100.0% |
| Polymer | | | | | | |
| Chain extender | 2.5% | 2.5% | 2.5% | 0.0% | 0.0% | 0.0% |
| Coat thickness | 10 | 15 | 20 | 10 | 15 | 20 |
| (mil) | | | | | | |
| UVC curing | 125 | 125 | 125 | 125 | 125 | 125 |
| (mJ/cm²) | | | | | | |
| Curing (final | 147.00 | 147.00 | 147.00 | — | — | — |
| panel temp) | | | | | | |
| Temp ramp | 9.00 | 9.67 | 9.67 | — | — | — |
| time (min) | | | | | | |

### Example 2

### Peel Strength and Shear Adhesion Testing

The formulations shown above in Example 1 were then tested for peel strength and shear adhesion failure (SAFT). The results are shown below in Table 2, wherein “CF” indicates cohesion failure. Each test was conducted three times. SS (stainless steel) peel testing was performed according to PSTC 101, wherein a sample is adhered by one end to a stainless steel panel and the free end is pulled. The average force and displacement values are recorded as the adhered portion is removed. SAFT evaluation was performed in accordance with PSTC 17 wherein a sample is adhered to a standard panel under controlled roll down. As standard mass is attached to the free end of the tape and the time to failure is determined.

TABLE 2

| | Formulation # | | | | | |
|---|---|---|---|---|---|---|
| | 1 | 2 | 3 | 4 | 5 | 6 |
| SS Peel (lbf) | 8.75855 | 7.37303 | 10.27693 | 16.20267 | 9.45971 | 4.97395 |
| 30 min dwell | 8.97581 | 9.47943 | 11.19078 | 15.84588 | 9.37503 | 5.09706 |
| | 9.47311 | 8.26677 | 11.59763 | 16.55532 | 9.81691 | 5.16651 |
| Avg. | 9.07 | 8.37 | 11.02 | 16.20 | 9.55 | 5.08 |
| Predominant | CF | CF | CF | CF | CF | CF |
| Failure | | | | | | |
| SAFT (° F.) | 180.2 | 163.6 | 79.6 | 159.5 | 77.2 | 75.5 |
| 1″ × 1″ × 1 kg | 170.8 | 155.5 | 88.1 | 170.8 | 79.5 | 75.5 |
| | 193.2 | 143.7 | 84.4 | 150.3 | 79.4 | 76.2 |
| Avg. | 180.40 | 154.27 | 84.03 | 160.20 | 78.70 | 75.73 |
| SAFT (min) | 105.2 | 88.6 | 4.6 | 84.5 | 2.2 | 0.5 |
| | 95.8 | 80.5 | 13.1 | 95.8 | 4.5 | 0.5 |
| | 118.2 | 68.7 | 9.4 | 75.3 | 4.4 | 1.2 |

### Example 3

### Peel Strength and Shear Adhesion Testing

To demonstrate the efficacy of the dual-cured adhesives of the present disclosure, two adhesive hot melt formulations were prepared, one comprising a UV-curable polymer and one comprising a UV-curable polymer and a thermally curable chain extender in a ratio of 97.5 wt. % to 2.5 wt. %. Each of the hot melt formulations were coating onto paper release liners at thicknesses of both 6 and 8 mils. The coatings were subjected to UV curing, then laminated onto 2 mil PET. The samples were cured using a Commercial Medium Pressure Mercury UV-Lamp, which, in addition to producing UV radiation of various wavelengths also provides secondary IR emission which may be utilized to cure the thermally curable component.

TABLE 3

| | UV | UV polymer + | UV | UV polymer + |
|---|---|---|---|---|
| | polymer | chain extender | Polymer | chain extender |
| Coating | 6 | 6 | 8 | 8 |
| thickness (mil) | | | | |
| UV-C dosage | 2 passes | 2 passes | 2 passes | 2 passes |
| (mJ/cm²) | of 163 | of 163 | of 163 | of 163 |
| SAFT | 159 | 170 | 141 | 164 |
| (° F.) | | | | |
| Peel off HDPE, | 6.1 (CF) | 6.9 (AF) | 10.7 (CF) | 7.5 (AF) |
| 30 min dwell | | | | |
| (lbs/in) | | | | |

Both SAFT and peel off HDPE were measured. As shown in Table 3, SAFT is higher and the peel failure mode changes from cohesive failure (CF) to adhesive failure (AF) in the samples including the thermally curable chain extender due to the increased level of cure. Without wishing to be bound by theory, this result may confirm the increased crosslinking provided by the addition of the thermally curable component.

The differences between the samples increased as the coating thickness increased, as shown in Table 3. As described above, UV curing is primarily surface curing in which the intensity of UV radiation decays exponentially as a function of the depth of the coating. This deficiency is overcome by utilizing the secondary IR emission if a thermally curable component is added into the UV curable adhesive.

Various modifications and alterations that do not depart from the scope and spirit of this invention will become apparent to those skilled in the art. This invention is not to be duly limited to the illustrative embodiments set forth herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

The term “substantially all of” means an amount or area coverage of 80% or more and is merely intended to serve as a shorthand method of referring individually to each separate value falling within the range from 80% to 100%.

Preferred embodiments of this invention are described herein, including the best mode known to the inventors for carrying out the invention. It should be understood that the illustrated embodiments are exemplary only and should not be taken as limiting the scope of the invention.

### Example 4

### Static Shear and Shear Adhesion Testing for PSA Grade Samples

To demonstrate the efficacy of the dual-cured adhesives of the present disclosure, two adhesive hot melt formulations were prepared, one comprising a UV-curable polymer and one comprising a UV-curable polymer and a thermally curable chain extender in a ratio of 97.5 wt. % to 2.5 wt. %, as shown below in Table 4. Each of the hot melt formulations were coating onto paper release liners at thicknesses of 1, 2 and 3 mils. Three of the coatings (samples 7, 8, and 9) were subjected to UV curing only, while samples 10, 11, and 12 were subjected to both UV and thermal cure. All samples were formulated for PSA grade applications.

TABLE 4

| | Formulation ID | | | | | |
|---|---|---|---|---|---|---|
| | 7 | 8 | 9 | 10 | 11 | 12 |
| UV-Curable Polymer | 100.00% | 100.00% | 100.00% | 97.50% | 97.50% | 97.50% |
| Chain extender | 0.0% | 0.0% | 0.0% | 2.5% | 2.5% | 2.5% |
| Coating Thickness (mil) | 1 | 2 | 3 | 1 | 2 | 3 |
| UV-C Dose, mJ/cm2 | 50.00 | 50.00 | 50.00 | 50.00 | 50.00 | 50.00 |
| Curing (final panel temp) | — | — | — | 147.00 | 147.00 | 147.00 |
| Temp Ramp total time (min) | — | — | — | 8.10 | 9.76 | 10.08 |

The samples were tested for static shear and shear adhesion failure (SAFT). The results are shown below in Table 5, wherein “CF” indicates cohesion failure, and “AF” indicates adhesive failure. Each test was conducted three times. SS (stainless steel) static shear testing was performed according to PSTC 107, wherein a one square inch sample is applied to a vertical standard stainless-steel panel and on the other end a standard mass was attached at another end to capture the shear resistance time. The average shear resistance values are recorded. SAFT evaluation was performed in accordance with PTSC 17 wherein a sample is adhered to a standard panel under controlled roll down. As standard mass is attached to the free end of the tape and the time to failure is determined.

TABLE 5

| | Formulation ID | | | | | |
|---|---|---|---|---|---|---|
| | 7 | 8 | 9 | 10 | 11 | 12 |
| SS Static Shear (min) | 2431 | 1903 | 1484 | 7597 | 5262 | 7838 |
| 30 min dwell | 2871 | 1565 | 770 | 12000 | 5882 | 5769 |
| | 3030 | 822 | 1483 | 12000 | 12000 | 8887 |
| Average | 2777.33 | 1430.00 | 1245.67 | 10532.33 | 7714.67 | 7498.00 |
| Failure Mode | CF | CF | CF | AF | AF | AF |
| SAFT (degrees F.) | 209 | 178 | 167 | 350 | 350 | 350 |
| 30 min dwell | 200 | 210 | 163 | 350 | 350 | 350 |
| | 208 | 177 | 156 | 350 | 350 | 350 |
| Average | 205.67 | 188.33 | 162.00 | 350.00 | 350.00 | 350.00 |
| Failure Mode | CF | CF | CF | No Failure | No | No |
| | | | | | Failure | Failure |

Both static shear and SAFT were measured for PSA applications. As shown in Table 5, static shear and SAFT is higher on both tests, and for the static shear the failure mode changes from cohesive failure (CF) to adhesive failure (AF), and for SAFT no failure was observed, in the samples including the thermally curable chain extender due to the increased level of cure.

Without wishing to be bound by theory, this result may confirm the increased crosslinking provided by the addition of the thermally curable component.

The differences between the samples increased as the coating thickness increased, as shown in Table 5. As described above, UV curing is primarily surface curing in which the intensity of UV radiation decays exponentially as a function of the depth of the coating. This deficiency is overcome by utilizing the secondary IR emission if a thermally curable component is added into the UV curable adhesive.

1.-37. (canceled)

38. A method of curing a hot melt adhesive composition, the method comprising:
subjecting the composition to both UV and thermal curing.

39. The method of claim 38, wherein the composition comprises:
an acrylic copolymer; and
a polymeric chain extender.

40. The method of claim 38, wherein the composition further comprises a photoinitiator.

41. The method of claim 40, wherein the photoinitiator comprises an ethylenically unsaturated copolymerizeable photoinitiator.

42. The method of claim 38, wherein the composition further comprises water-borne latex adhesive.

43. The method of claim 42, wherein the water-borne latex adhesive comprises at least one styrene/acrylic latex, acrylic latex, styrene butadiene latex or nitrile butadiene latex derived from at least one monomer selected from the group consisting of styrene, 2-ethylhexyl acrylate, methyl acrylate, methyl methacrylate, ethyl acrylate, ethyl methacrylate, butyl acrylate, butyl methacrylate, acrylamide, acrylic acid, methacrylic acid, itaconic acid, and vinylphosphonic acid.

44. The method of claim 38, wherein the composition is applied to a substrate as a coating.

45. The method of claim 38, wherein the substrate comprises one or more of a polymeric membrane, gypsum, oriented strand board (OSB), metal, plywood, plastic, paper, cardboard, glass, fiberboard, and ceramic.

46. The method of claim 45, wherein the polymeric membrane is selected from the group consisting of thermoplastic membrane, ethylene-propylene-diene terpolymer rubber (EPDM), thermoplastic polyolefin (TPO), polyvinyl chloride (PVC), nonwoven polypropylene, nonwoven polyethylene, nonwoven polyethylene terephthalate, woven polypropylene, woven polyethylene, spunbond polypropylene, spunbond polyester, modified bitumen, rubber membrane, asphaltic membranes, fibrous membranes and flexible membranes selected from the group consisting of BOPP (bi-axially oriented polypropylene), polyethylene terephthalate (PET), and polyethylene furanoate (PEF), and polytrimethylene furandicarboxylate (PTF).

47. The method of claim 42, wherein the thickness of the coating is between 0.5 mils (12.7 μm) and 30 mils (762 μm).

48. The method of claim 47, wherein the thickness of the coating is between 0.5 mil (12.7 μm) and 4 mils (101.6 μm).

49. The method of claim 47, wherein the thickness of the coating is between 5 mils (127 μm) and 20 mils (508 μm).

50. The method of claim 47, wherein the thickness of the coating is between 20 mils (508 μm) and 30 mils (762 μm).

51. The method of claim 38, wherein the composition is subjected to UV curing at a wavelength of 240-280 nm.

52. The method of claim 38 wherein the composition is subjected to at least one pass of UV curing at a dose of 5-300 mJ/cm².

53. The method of claim 52, wherein the composition is subjected to multiple passes of UV curing.

54. The method of claim 52, wherein the composition is subjected to one pass of UV curing.

55. The method of claim 38, wherein the composition is subjected to thermal curing at a temperature of 80° C. or greater.

56. The method of claim 38, wherein the composition is subjected to thermal curing for a time period of upto about 60 minutes.

57. The method of claim 44, wherein the coating is applied as a single layer.

58. The method of claim 44, wherein the coating is applied as successive layers.

59. The method of claim 38, wherein the composition undergoes UV curing prior to thermal cure.

60. The method of claim 38, wherein the composition undergoes thermal curing prior to UV curing.

61. The method of claim 38, wherein the composition undergoes thermal and UV curing simultaneously.

62. A coated article, wherein the coating comprises a hot melt adhesive, and wherein the coating undergoes both UV and thermal curing.

63. The coated article of claim 62, wherein the hot melt adhesive comprises:
an acrylic copolymer; and
a polymeric chain extender.

64. The coated article of claim 63, further comprising a photoinitiator.

65. The coated article of claim 63, wherein the hot melt adhesive further comprises a water-borne latex adhesive.

66. The coated article of claim 65, wherein the water-borne latex adhesive comprises at least one styrene/acrylic latex, acrylic latex, styrene butadiene latex or nitrile butadiene latex derived from at least one monomer selected from the group consisting of styrene, 2-ethylhexyl acrylate, methyl acrylate, methyl methacrylate, ethyl acrylate, ethyl methacrylate, butyl acrylate, butyl methacrylate, acrylamide, acrylic acid, methacrylic acid, itaconic acid, and vinylphosphonic acid.

67. The coated article of claim 62, wherein the coated article is suitable for use in roofing, construction, papers, tapes, and high temperature applications.

68. The coated article of claim 62, wherein the coated article is suitable for use in exterior and interior applications.

69. A multilayer composite comprising:
a hot melt adhesive comprising:
an acrylic copolymer;
a polymeric chain extender;
a polymeric membrane; and
a release liner;
wherein the multilayer composite is subjected to both UV and thermal curing.

70. The multilayer composite of claim 69, wherein the hot melt adhesive further comprises a photoinitiator.

71. The multilayer composite of claim 68, wherein the hot melt adhesive further comprises a water-borne latex adhesive.

72. The multilayer composite of claim 71, wherein the water-borne latex adhesive comprises at least one styrene/acrylic latex, acrylic latex, styrene butadiene latex or nitrile butadiene latex derived from at least one monomer selected from the group consisting of styrene, 2-ethylhexyl acrylate, methyl acrylate, methyl methacrylate, ethyl acrylate, ethyl methacrylate, butyl acrylate, butyl methacrylate, acrylamide, acrylic acid, methacrylic acid, itaconic acid, and vinylphosphonic acid.

73. A coated article comprising:
the multilayer composite of claim 69; and
a substrate.

74. The coated article of claim 73, wherein the substrate comprises nonwoven polypropylene, nonwoven polyethylene, nonwoven polyethylene terephthalate, woven polypropylene, woven polyethylene, spunbond polypropylene, spunbond polyester, and combinations thereof.
